(19) United States
(12) Patent Application Publication
(10) Pub. No.: US 2016/0050454 A1
(43) Pub. Date: Feb. 18, 2016

(54) PROTECTION OF DIGITAL CONTENT

(71) Applicant: IRDETO B.V., Hoofddorp (NL)

(72) Inventors: Dan Murdock, Ottawa (CA); Greg McKesey, Ottawa (CA)

(21) Appl. No.: 14/779,245

(22) PCT Filed: Mar. 28, 2013
(86) PCT No.: PCT/EP2013/056745

§ 371 Date: Sep. 22, 2015

(51) Int. Cl. H04N 21/4405; H04L 29/06

(52) U.S. Cl. CPC H04N 21/4405; H04L 63/0428

(57) ABSTRACT

Protection of digital content, for example content on an optical disk, is discussed. A first content protection system such as AACS processes its specific content protection information to yield a first result which is differently obscured for different media players. A second content protection system such as BD+ processes the first result and its own specific content protection information to yield a second result which can be used to reproduce protected content such as encrypted video on the optical disk.

### FIELD OF THE INVENTION

The invention relates to the delivery of protected digital content, for example to the delivery of encrypted audio and/or video data using an optical disk medium and a PC media player executing on a general purpose computer such as a PC, tablet or smart phone.

### BACKGROUND OF THE INVENTION

The Advanced Access Content System (AACS) provides protection of digital content, and is described in detail in http://www.aacsla.com/specifications. AACS is used, for example, to protect content on Blu-ray (®) optical disks by obscuring the title keys Kt which are used in a media player to decrypt content read from the Blu-ray disk. AACS obscures the title keys in a manner which is cryptographically linked to an AACS device keyset specific to and held at the media player. In particular, a media key block (MKB) written on a Blu-ray disk can be configured to prevent any chosen subset of media players from reading the disk, a measure which can be used to exclude compromised media players.

A media player on which AACS and/or other content protection systems operate may be a dedicated media player unit delivered for example as part of a television or as a standalone Blu-ray disk player for connection to a television. Although it will be appreciated that content protection schemes in such a media player are mostly effected using pre-installed software, it may be difficult to upgrade or change the software in a dedicated media player after manufacture. On the other hand, it is generally possible to implement various hardware based protection schemes against compromise of the content protection systems used.

Alternatively, a media player may be operated on a general purpose computer, such as a desktop or laptop personal computer, or on a tablet computer or a smart phone, and in this document such a media player is generally referred to as a PC media player. A PC media player may typically be distributed as a piece of software, for example over a network connection or using a computer readable medium, or be preinstalled on a computer device before delivery to an end user. It is more difficult to implement hardware based protection of the content protection systems in such a media player because of the general purpose nature of the computer equipment on which the player operates. However, conventionally, a PC media player will go through a number of subsequent release versions with minor or major modifications between each such release, and users of the PC media player may be offered the opportunity, or be required, to upgrade to a more recent version from time to time. Such upgrades offer providers of such PC media players opportunities to update content protection related data held within such media players.

FIG. 1 provides a simplified view of a prior art AACS system in operation by a media player 30, in combination with a hardware reader such as a Blu-ray drive 5, to read a medium such as a Blu-ray disk 10 in order to provide title keys Kt for decrypting encrypted content 18 held on the disk.

Although not illustrated in FIG. 1, a step of drive authentication is typically first carried out in which the media player 30 and the Blu-ray drive 5 or other hardware reader each verify that the other has not been revoked using the MKB 12 found on the disk, prior to establishing a bus key between them using an EC-DH (Elliptic curve Diffie-Helman) process. A process MKB function 32 then uses the MKB 12 in combination with an AACS device keyset 34 to compute a media key Km which is passed to an AES-G transform 36. In practice, a media key precursor may be combined with a processing key to form the media key, although this level of detail is not shown in FIG. 1.

The AACS device keyset 34 is typically unique to a particular media player. In the case of a dedicated unit media player, the AACS device keyset 34 may be different for each dedicated unit. In the case of a PC media player, it would be more normal for a particular AACS device keyset 34 to be common to all installed copies of a particular software release version of the PC media player.

In dedicated unit media players it is also usual for an extra step to be implemented between the process MKB function 32 and the AES-G function 36, which is not illustrated in FIG. 1. This step accepts key conversion data (KCD) read from the disk 10, and uses this in an extra KCD transform function to convert a media key precursor generated by the process MKB function 32 into the media key Km. This KCD transform function is rarely implemented in PC media players. The type 4 MKB (see the AACS LA document “Advanced Access Content System (AACS)—Pre-recorded Video Book, Revision 0.953 (Final), Oct. 26, 2012, available from http://www.aacsla.com/specifications) currently required in all pre-recorded Blu-ray disks supports both KCD and non-KCD media players.

The AES-G transform 36 combines the media key Km with a volume ID 14 read from the Blu-ray disk 10 to produce a volume unique key Kvm which is passed to a title key decryption function 38. The title key decryption function 38 uses the volume unique key Kvm to decrypt encrypted title keys 16 read from the disk 10, and the title keys Kt are then used by a content decryption function 40 to decrypt encrypted content 18 read from the disk 10.

Although not shown in FIG. 1, the media player 30 may also use the BD+system to carry out subsequent processing of the decrypted content, thereby providing another layer of content protection. The BD+ system is described in detail in U.S. Pat. No. 7,778,420. To implement this, BD+ code would be read from the disk 10 and passed to a BD+ virtual machine operating in the media player 30, which operates subject to the availability of correct BD+ identity data in or available to the media player 30. Typically, the BD+ virtual machine may provide fixups to produce viewable video in the content, and/or a variety of other content protection related measures.

The media key Km (and processing key), and the title keys Kt are typically different for each Blu-ray title, but in the prior art are usually common to all media players. The AACS device keyset 34 is used in the AACS processing of FIG. 1 to prove media player identity by providing unique paths in the MKB to a processing key/media key pair. However, there is no diversity between media players in the process chain of FIG. 1 after the media key has been computed, and there is currently only one processing key/media key pair, so no forensic information exists at that stage. The constraint of a single content stream on a disk 10 implies that both the MPEG2 transport stream data itself and the title keys Kt must be common in all playback scenarios, unless segment keys are used as described at page 43 in the AACS LA document “Advanced Access Content System (AACS)—HD DVD and DVD Pre-recorded Book, Revision 0.952 (Final), Jul. 14, 2011, available from http://www.aacsla.com/specifications.

The way in which AACS is typically implemented in PC media players gives rise to a number of threats to the security of the content protection system. For example, device keys or the code and tables required to achieve their effect in processing the MKB have been pirated from PC media players and used in rippers as a class circumvention device. A processing key can be discovered in memory of a running PC media player and can then be circulated to other parties. One processing key can be used to decrypt media keys from an entire version of the MKB, and because there is only one media key per Blu-ray title, only one processing key is needed to compromise security even if there is diversity in the processing key between different AACS device keysets 34. The sole media key for a Blu-ray title may be discovered in a PC media player memory and circulated online. The volume ID 14 may be discovered in memory or recovered using an unrevoked host certificate and circulated online. The volume unique key can be derived or discovered in memory and distributed, and title keys can be decrypted using an illegitimately obtained volume unique key, or discovered in player memory.

The invention address problems and limitations of the related prior art.

### SUMMARY OF THE INVENTION

The invention provides an arrangement whereby a first content protection system processes its specific content protection information to yield a first result which is passed to a second content protection system. The second content protection system processes the first result in combination with content protection information specific to the second content protection system to produce a second result, such as key information, which is used directly or indirectly for reproducing protected content.

The invention can be implemented such that the first result comprises key information which is not sufficient to reproduce the content, and in which the key information is obscured differently for different media players, for example for media players issued by different manufacturers, or different release versions of a particular media player. The second content protection system may then apply a transformation to the first result to yield the key information in a form useable to reproduce (for example to decrypt) the protected content.

In particular, the invention provides a source comprising or arranged to provide content for reproduction by each of a plurality of different computer implemented media players. The source could, for example, be provided by an optical disk such as a Blu-ray® disk, other types of computer readable media, network connection to one or more servers, and in other ways. The source comprises or is arranged to provide to the media players: first content protection material arranged for processing by each of said different media players, according to a first content protection system, to generate a differently obscured version of a first result for each different media player; second content protection material arranged for processing by each of said different media players, according to a second content protection system, in combination with the first result generated by that media player, to generate a second result, provided in a same version for each media player; and protected content arranged to be reproduced by each of said media players using said second result.

Note that further processing of the second result may be required before the protected content can be reproduced. The second result may, for example comprise key data such as a content key for use in reproducing said protected content by decryption, or a media key requiring further processing to generate a content key. Each version of the first result may comprise the same key data, but obscured differently for each different media player. The second content protection material may then define a different transformation of the obscured key data of the first result for use by each different media player, so as to recover the same key data at each media player.

The first and second content protection systems may be, for example, an AACS and a BD+ system respectively.

The invention also provides a media player for reading from such a source, for example comprising: a first content protection system function arranged to generate a first result from first content protection material; a second content protection system function arranged to generate a second result from second content protection material and the first result; and a content decryption function arranged to reproduce said content from said protected content using the second result.

The invention also provides a plurality of such media players, a plurality of such media players in combination with one or more sources as discussed above, a computer readable medium carrying computer program code arranged to put into effect such a media player on suitable computer equipment, and a computer comprising a media player and a media reader for reading a source as discussed above.

### BRIEF DESCRIPTION OF THE DRAWINGS

Embodiments of the invention will now be described, by way of example only, with reference to the accompanying drawings of which:

FIG. 1 illustrates an implementation of AACS in simplified form;

FIG. 2 shows a source and a media player according to an embodiment of the invention;

FIG. 3 shows a more specific implementation of the embodiment of FIG. 2 using AACS and BD+ content protection systems.

### DETAILED DESCRIPTION OF EMBODIMENTS OF THE INVENTION

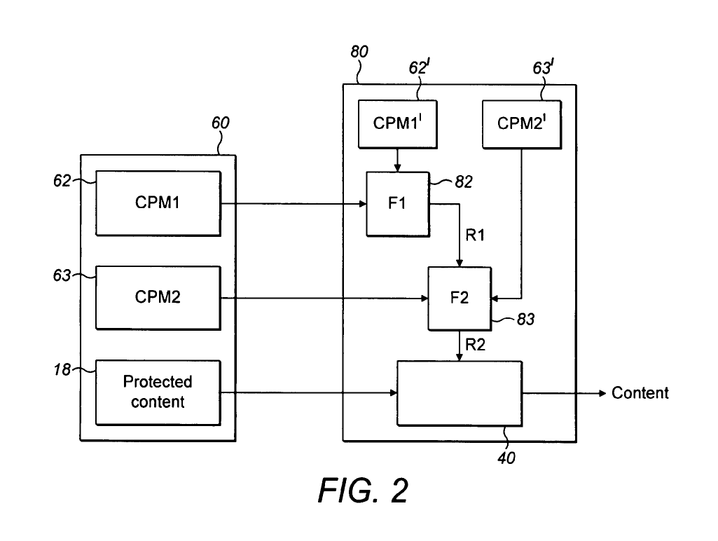

FIG. 2 illustrates how the invention may be implemented in a media player 80, which is preferably a software or PC media player. A source 60 makes available to the media player 80 first content protection material 62 relating to a first content protection system, second content protection material 63 relating to a second content protection system, and protected content 18. The source 60 may be, for example, an optical disk read using a hardware drive (not illustrated in FIG. 2, but which may be for example an optical disk drive installed in the PC or other device executing the PC media player) and passed to the media player 80. However, the source may be provided by another type of computer readable medium such as a flash drive, or may be implemented using a broadcast or network streaming from one or more servers, from a memory of the computer running the media player, and in many other ways including combinations of different source types.

In order to reproduce the protected content 18, the media player 80 receives the first content protection material 62, and processes this material for example in combination with further first content protection material 62′ (which may typically be held at or be part of the media player software, for example as a media player keyset, or otherwise held at the computer executing the media player) according to the first content protection system, to provide a first result R1. This processing by the media player is shown in FIG. 2 as being carried out by a first content protection system function 82.

The media player 80 also receives the second content protection material 63 from the source 60, and processes this material optionally in combination with further second content protection material 62′ (which may typically be held at or be part of the media player software, for example as a media player keyset, or otherwise stored at the computer executing the media player) according to the second content protection system, to provide a second result R2. This processing by the media player is shown in FIG. 2 as being carried out by a second content protection system function 83, and requires the first result R1 in order to produce the correct second result R2.

The second result R2 is then required in order for a content reproduction function 40 to reproduce the protected content 18 received from the source 60.

The media player 80 is one of a plurality of different media players, which are different to each other at least in that each different media player generates a different version of the first result, and transforms this different version of the first result in a different way to generate the second result. Each version of the first result R1 may be specific, for example, to a media player produced by a particular manufacturer, or to a particular media player or release version of a particular media player.

Each of the first and second results may comprise, for example, a content key. However, the content key in the obscured form in which it is comprised within the first result is then not suitable or sufficient to recover the decrypted content, because further processing is still required by the second content protection system. Moreover, the obscured content key as comprised within the first result may be differently protected or obscured for different protection types, versions or instances of the second content protection system and in particular of the second content protection system function 82 when implemented using the second content protection material 63.

At least one of the first and second content protection systems should support the coordination of multiple content protection systems. This coordination support may involve data exchange as well as sequencing operations to decrypt/decode/render the content, which may involve processing by a content protection system. One example of cooperating content protection systems is provided by the DVB SimulCrypt specification. The DVB SimulCrypt specification describes a protocol that can be used to exchange the content keys, to coordinate the distribution of keys and to schedule the timing of the use of the keys.

The second content protection system may comprise a key loading system that accepts transformed content key data from the first content protection system, as or within the first result. The key loading system then uses the transformed content key data to derive one or more keys that are needed to decrypt and to optionally further process the encrypted content 18. The transformation used may be different for different implementations of the second content protection system.

The second content protection system function 83 may in particular apply a transformation to the obscured media key precursor or first result, such as a KCD like transformation.

At least some of the first and second content protection material 62, 63, 62′, 63′ is formatted or generated in a way that involves both the first and second content protection systems. For example, the first portion 62′ of the first content protection material may be arranged such that the second result, for example a content key, can only be recovered using both the first and second content protection system functions 82, 83. In particular, the source 60 provides content for reproduction by each of the plurality of different computer implemented media players, first content protection material arranged for processing by each of said different media players according to the first content protection scheme to generate a different version of the first result, second content protection material arranged for processing by each of the different media players according to the second content protection scheme, in combination with the first result generated by that media player, to generate a second result. The protected content available from the source is then arranged to be reproduced by each of the different media players using the second result.

In some specific embodiments, the first content protection system may be the Advanced Access Control System (AACS) or a similar system, in which case the first content protection material 62 available from the source may comprise an ACCS media key block (MKB) for processing by the first content protection system function 82 with reference to an AACS device keyset comprised in the further first content protection material 62′. The first result may then be or comprise an obscured media key precursor.

In some specific embodiments the second content protection system may be a BD+, or similar system, wherein the second content protection material 63 available from the source 60 may include executable code for execution by a virtual machine comprised in or formed by the second content protection system function 83 with reference to identity data such as BD+ identity data comprised in the further second content protection material 63′.

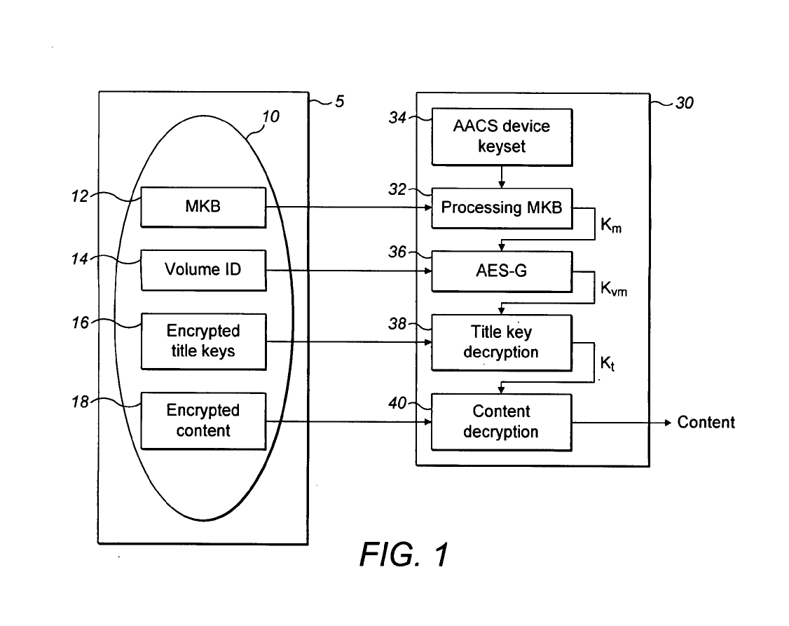

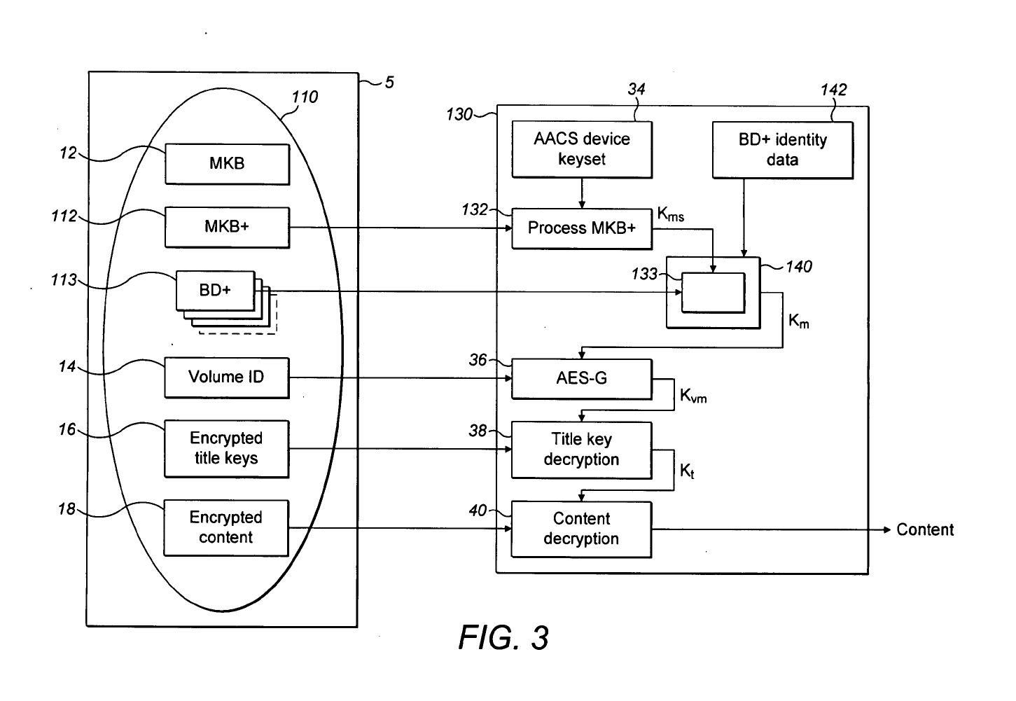

With reference to FIG. 3, an implementation of the arrangement of FIG. 2, in the context of Blu-ray® disk technology implemented in PC media players, using AACS and BD+ schemes for the first and second content protection systems, will now be described. For brevity, elements of FIG. 3 which correspond closely to those of FIG. 1 are not necessarily described again here, and may bear the same reference numerals.

To implement the data source 60 of FIG. 2, a conventional Blu-ray drive 5 is used to read data from a Blu-ray optical disk 110. A type 4 media key block 12 for use with a conventional AACS process may be provided on the optical disk 110 if required for compatibility with prior art media players, but the adapted optical disk 110 also includes a revised media key block 112 denoted here as MKB+, which forms part of the first content protection system material 62 of FIG. 2.

A PC media player 130 arranged to implement the invention includes a process MKB function 132 which processes the MKB+ in the usual way with reference to a locally stored AACS device keyset 34 (and implements at least a part of the first content protection system function 82 of FIG. 2). However, in comparison with the prior art arrangement of FIG. 1, the MKB+ is arranged such that the output of the process MKB function 132 is not the media key Km required as input to the AES-G function 36, or a media key precursor as found in a conventional KDC type media player. Instead, the MKB+ causes the process MKB function 132 to output a player specific media key precursor Kms which is different for different PC media players as reflected in the AACS device keyset 34 for a particular player. The player specific media key precursor Kms could be specific to each released version of the software PC media player as reflected in each different AACS device keyset 34. However, in the present embodiment, the player specific media key precursor Kms is specific to each of a plurality of different PC media player brands or manufacturers.

In the PC media player 130, the player specific media key precursor Kms is passed to a media key transform function 133 implemented using a BD+ code segment 113 within a BD+ virtual machine 140 executing as part of the PC media player 130. The BD+ virtual machine corresponds to the second content protection system function 83 of FIG. 2. The correct operation of the BD+ virtual machine 140 is dependent upon receiving BD+ identity data 142 bound to the PC media player 130. Moreover, the media key transform function 133 varies dependent on the BD+ identity data 142. This is achieved by providing multiple BD+ code segments 113 on the Blu-ray disk, and arranging the PC media player 130 to use a BD+ code segment determined with reference to the BD+ identity data. The BD+ code segments on the Blu-ray disk correspond to at least a part of the second content protection material 63 of FIG. 2. In the present embodiment, a different BD+ code segment 113 is provided on the Blu-ray disk 110 for each of the plurality of different PC media player brands or manufacturers, and the BD+ code segment 113 which will provide the correct transform of the player specific media key precursor Kms is used to correctly derive the media key Km.

When the correct media key Km has been derived by the BD+ virtual machine 140, it is passed on to other parts of the AACS key processing chain in the usual way, for example to derive the volume unique key Kvm and the title keys Kt.

The media key transform function 133 may be similar to the KCD transform implemented in KCD media players.

If a Blu-ray disk lacking the MKB+ is loaded into the drive 5 then the PC media player 130 recognises this and instead reads and processes the type 4 MKB 12 using a conventional AACS process without transformation using the BD+ virtual machine 140, for example as already shown in FIG. 1.

The BD+ code segments 113 may be different for each Blu-ray title as well as for each different brand or manufacturer of PC media player. In some embodiments, the BD+ code segments 113 provide the only way to apply the media key transformation function 133, and are encrypted on the Blu-ray disk 110 and accessible only using keys included in the BD+ identity data associated with the PC media player 130, thereby cryptographically binding BD+ to AACS. This cryptographic binding gives the organisations managing the AACS and BD+ services and key sets the ability to coordinate forensic efforts given the legal ability to do so.

In particular, demonstration through BD+ forensic analysis of a BD+ key exposure then implies exposure of the AACS keys linked to the same PC media player, so that the PC media player should be renewed. Similarly, demonstration through AACS forensic analysis of AACS key exposure implies exposure of the BD+ keys linked to the same PC media player, so that again the PC media player should be renewed. Forensic information gained through hybrid security benefits multiple aspects of Blu-ray content protection, and not only BD+ content owners. Between the AACS organisation and the BD+ organisation, the proper course of action to be taken by one or both of these parties can be determined.

Other potential benefits can include leveraging both AACS and BD+ forensic marking to improve compromised player identification, and minimizing the cost of forensics by leveraging the most efficient aspects of each forensic scheme.

It will be understood that variations and modifications may be made to the described embodiments without departing from the scope of the invention as defined in the appended claims. For example, it is to be understood that any feature described in relation to any one embodiment may be used alone, or in combination with other features described in respect of that or other embodiments.

1. A source arranged to provide content for reproduction by each of a plurality of different computer implemented media players, comprising:
first content protection material arranged for processing by each of said different media players according to a first content protection system to generate a different version of a first result in each different media player;
second content protection material arranged for processing by each of said different media players according to a second content protection system, in combination with the first result generated by that media player, to generate a second result; and
protected content arranged to be reproduced by each of said media players using said second result.

2. The source of claim 1 wherein the second result comprises key data for use in reproducing said protected content, and each version of the first result comprises the same key data obscured differently for each different media player.

3. The source of claim 2 wherein the second content protection material defines a different transformation of the obscured key data of the first result for use by each different media player.

4. The source of claim 3 wherein the different transformations are defined by different software code segments comprised in the second content protection material, each of the software code segments being arranged for execution by a corresponding one of the different media players.

5. The source of claim 4 wherein the software code segments are BD+ code segments.

6. The source of any preceding claim wherein the first content protection material comprises an AACS media key block.

7. The source of any preceding claim wherein the source is a computer readable medium.

8. The source of any preceding claim wherein the source is an optical disk.

9. The source of any preceding claim wherein each of the plurality of different media players is a media player produced by different manufacturer.

10. The source of any preceding claim wherein none of the plurality of different media players is a same release version of a particular software media player as another of the different media players.

11. A media player comprising:
a first content protection system function arranged to generate a first result from first content protection material;
a second content protection system function arranged to generate a second result from second content protection material and the first result; and
a content decryption function arranged to reproduce said content from said protected content using the second result.

12. The media player of claim 10 arranged to receive at least a part of said first content protection material, at least a part of said second content protection material, and at least a part of said protected content, from a source according to any of claims 1 to 10.

13. The media player of claim 10 or 11 wherein the first content protection system function is an AACS function arranged to process an MKB comprised in the first content protection material to yield a media key precursor comprised in the first result.

14. The media player of any of claims 11 to 13 wherein the second content protection system function is a BD+ function arranged to execute BD+ code segments comprised in the second content protection information to transform the first result to yield a media key.

15. A plurality of media players according to any of claims 11 to 14 in combination with a source according to any of claims 1 to 10, arranged such that each different media player generates a differently obscured version of the same key data as the first result.

16. The plurality of media players in combination with a source according to claim 15 arranged such that each different media player selectively uses the second content protection material to apply a different transformation to the obscured key data of the first result.

17. A computer readable medium comprising computer program code arranged to put into effect the media player of any of claims 11 to 14.

18. A computer comprising a media reader for reading from a source according to any of claims 1 to 10, and a media player according to any of claims 11 to 14 operably coupled to the media reader.
